(19) United States
(12) Patent Application Publication
(10) Pub. No.: US 2012/0262302 A1
(43) Pub. Date: Oct. 18, 2012

(54) POWER PLUG WITH SAFETY PROTECTION

(76) Inventor: HSU-YING CHANG, Taichung City (TW)

(21) Appl. No.: 13/087,383

(22) Filed: Apr. 15, 2011

(51) Int. Cl. H02H 9/08

(52) U.S. Cl. 340/815.4; 361/93.9

(57) ABSTRACT

A power plug with safety protection comprises a main body, two blades, two wires or electrical conducting clips, a circuit isolating means for selectively opening or closing a circuit in the main body so as to supply or cut off power, and a current limiting means. One of the blades is connected to one of the wires or one of the electrical conducting clips by way of the circuit isolating means in series, the other of the blades is connected to the other of the wires or the other of the electrical conducting clips by way of the current limiting means, so as to form an electrical loop of dual safety protection. The circuit isolating means can be switched off to cut off power when equipments are not in use. The current limiting means can be actuated to trip equipments upon abnormal or excessive current.

### (a) TECHNICAL FIELD OF THE INVENTION

The present invention relates to a power plug with safety protection and, more particularly, to power plug that allows an electrical equipment to be isolated from a power source when the equipment is not in use, and can be actuated to cut off the power source when abnormal current occurs to achieve the purpose of energy saving and electrical safety protection.

### (b) DESCRIPTION OF THE PRIOR ART

Electrical equipments generally use a power plug to connect to a power source with a voltage of 110 or 220 volts. When the electrical equipments are not used, under most conditions, a user only cuts off the power supply to the equipment via the built-in switches of the equipments. In some electrical equipment, the power cannot be completely cut off through the built-in switch and thus may cause unnecessary energy consumption. It is however inconvenient and unsafe for a user to unplug the plug each time after the equipment has been used. Thus, there is a need for improvement. Furthermore, conventional plugs usually cannot afford safety protections under the condition of abnormal or excessive current, such as overload, which is a major cause common seen in several accidents or misfortunes due to carelessness. In view of the foregoing, according to the long-term experiences and constant efforts on research and experiment, the applicant has contrived a structure of power plug that can achieve the purpose of energy saving and electrical safety protection when electrical equipments are not in use.

### SUMMARY OF THE INVENTION

The primary object of the present invention is to provide a power plug with safety protection that can isolate an electrical equipment from a power source when the equipment is not in use, and can automatically cut off the power source when abnormal or excessive current occurs, so as to achieve the purpose of power saving and electrical safety protection.

The power plug comprises a main body, two blades being provided at one end of the main body, two wires or electrical conducting clips being provided at the other end of the main body, a circuit isolating means mounted in the main body for selectively opening or closing a circuit in the main body so as to supply or cut off power, and a current limiting means mounted in the main body. In the main body, one of the two blades is connected to one of the wires or one of the electrical conducting clips by way of the circuit isolating means in series, the other of the two blades is connected to the other of the two wires or the other of the electrical conducting clips by way of the current limiting means, so as to form an electrical loop of dual safety protection. When an electrical equipment connected to a power source by the power plug is not in use, the circuit isolating means can be switched off to cut off the power source to save power and allows the electrical equipment to be isolated from the power source to achieve the purpose of power saving and electrical safety protection. When abnormal or excessive current such as overload occurs, the current limiting means can be actuated to cut off the power source to achieve the purpose of electrical safety protection as well.

The circuit isolating means can be a switch in practical application.

Alternatively, the circuit isolating means can be a switch with an indicating lamp.

The current limiting means can be a fuse to provide a safety protection under the condition of abnormal or excessive current.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view of a first embodiment according to the present invention.

FIG. 2 is an assembly drawing, which shows a structure of the first embodiment according to the present invention.

FIG. 3 is an assembly drawing, which shows another structure of the first embodiment according to the present invention.

FIG. 4 is a 3-dimensional view of a second embodiment according to the present invention.

FIG. 5 is another 3-dimensional view of the second embodiment according to the present invention.

FIG. 6 is an assembly drawing, which show a structure of the second embodiment according to the present invention.

FIG. 7 is an assembly drawing, which shows another structure of the second embodiment according to the present invention.

### DETAILED DESCRIPTION OF THE PREFERRED EMBODIMENTS

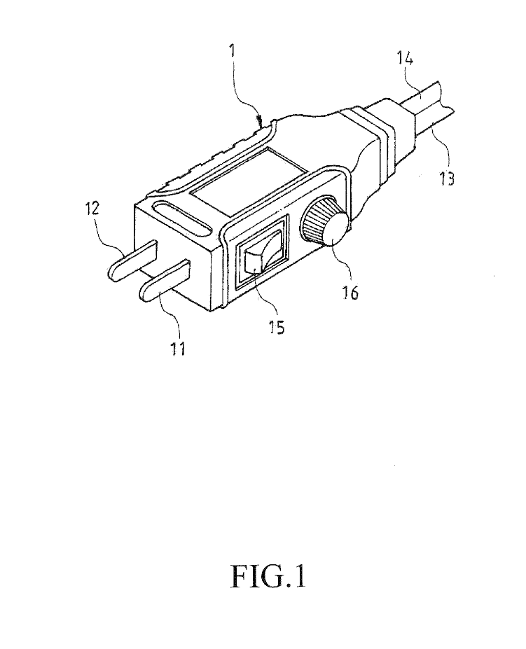

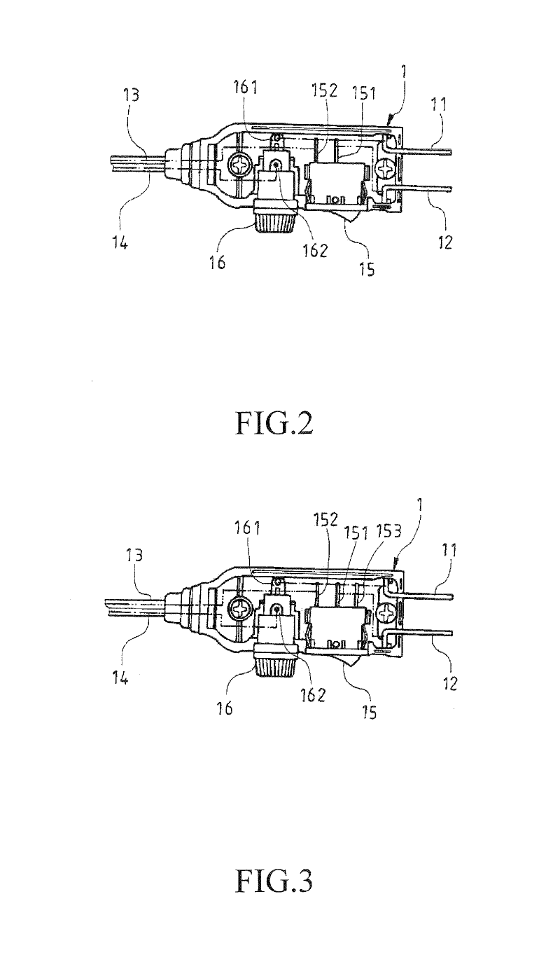

Please refer to FIG. 1 and FIG. 2, which are respectively a 3-dimensional view and an assembly drawing of a structure of a first embodiment according to the present invention. As shown, the power plug of the present invention comprises a main body 1, two blades 11, 12 being symmetrically arranged on one end of the main body, two wires 13, 14 being provided at the other end of the main body, a circuit isolating means 15, and a current limiting means 16. The circuit isolating means 15 is mounted in the main body 1 and has a portion exposed outside of the main body 1 for selectively closing or opening a circuit in the main body 1 so as to supply or cut off power. The current limiting means 16 has a portion exposed outside of the main body 1 and is mounted in the main body 1 for tripping an electrical equipment (not shown) connected to a power source by the power plug when abnormal or excessive current occurs. In this embodiment, the circuit isolating means 15 is a switch. The current limiting means 16 is a through-chassis fuse holder containing a fuse therein, which has a specific current rating dependent on an application. Furthermore, the blade 11 is connected to the first contact 161 of the current limiting means 16. The wire 14 is connected to the second contact 162 of the current limiting means 16. The blade 12 is connected to the first contact 151 of the circuit isolating means 15. The wire 13 is connected to the second contact 152 of the circuit isolating means 15.

The blade 11, the wire 14, and the current limiting means 16 are connected in series while the blade 12, the wire 13, and the current isolating means 15 are connected in series, and thus forms an electrical loop of dual safety protection. Therefore, when the user wants to use an electrical equipment connected to a power source by the power plug, the circuit isolating means 15 can be switched on to supply power to the electrical equipment. When the electrical equipment is not in use, the circuit isolating means 15 can be switched off to cut off power to save power. When abnormal or excessive current such as overload occurs, the current limiting means 16 can be actuated to cut off power to trip the electrical equipment to achieve the purpose of electrical safety protection.

In case of abnormal or excessive current, the power plug of the present invention can afford protecting actions for the equipment. In other words, when abnormal or excessive current occurs as a result of an abnormal condition of the electrical equipment, the fuse in the current limiting means 16 can be melted due to excessive current such that the electrical equipment can be insulated from the power source so as to protect the electrical equipment and provide a safety protection. After the abnormal condition is eliminated, the user can replace the melted fuse with a new one.

Please refer to FIG. 3, which shows another structure of the first embodiment according to the present invention. As shown, the circuit isolating means 15 is a switch with an indicating lamp (lamp not shown). The blade 11 is connected to the third contact 153 of the circuit isolating means 15 and then connected to the first contact 161 of the current limiting means 16. The wire 14 is connected to the second contact 162 of the current limiting means 16. The blade 12 is connected to the first contact 151 of the circuit isolating means 15. The wire 13 is connected to the second contact 152 of the circuit isolating means 15. Since the indicating lamp (not shown) is connected between the second contact 152 and the third contact 153 of the circuit isolating means 15, when the circuit isolating means 15 is switched on, the indicating lamp (not shown) can illuminate so as to increase the usefulness of the power plug.

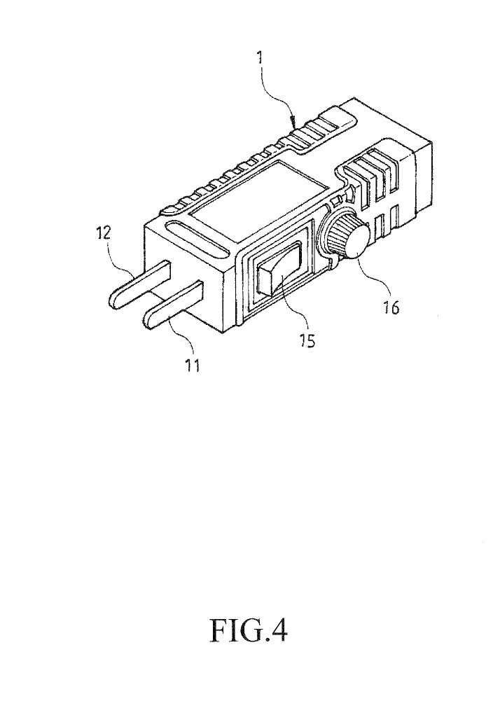

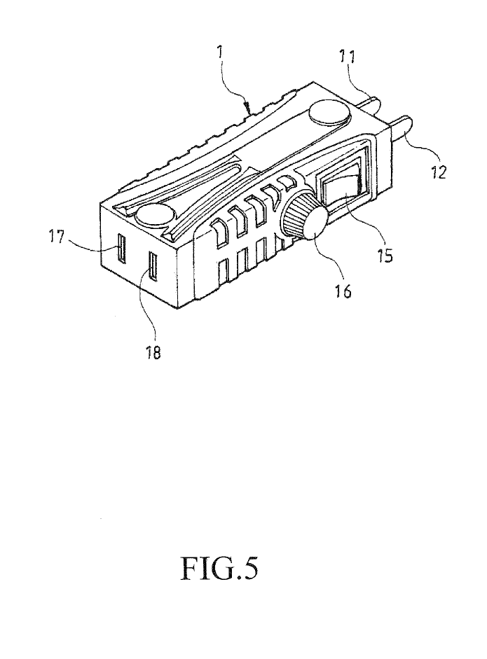

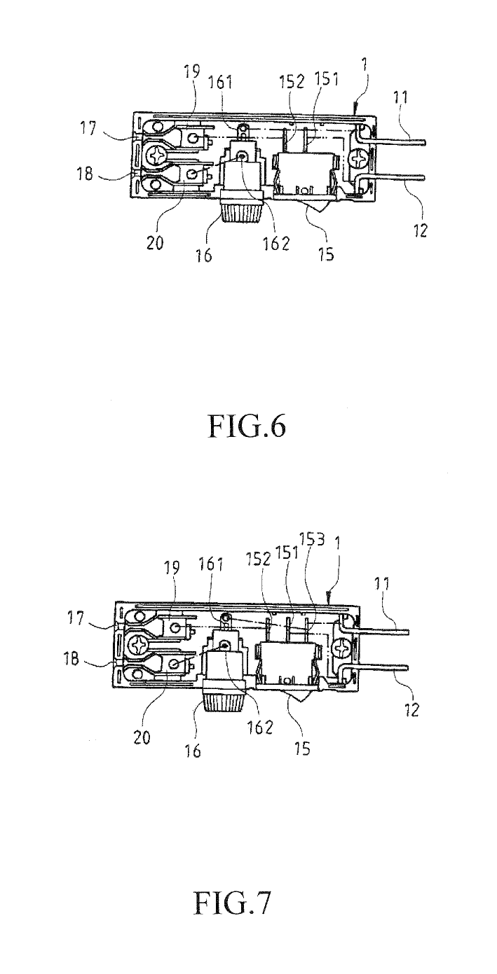

Please refer to FIGS. 4-6, which are respectively 3-dimensional views and an assembly drawing of a structure of a second embodiment according to the present invention. As shown, the power plug of the present invention comprises a main body 1, two blades 11, 12 being symmetrically arranged at one end of the main body, two slots 17, 18 being provided at the other end of the main body, two electrical conducting clips 19, 20, which corresponds to the slots 17, 18, being mounted in the main body, a circuit isolating means 15, and a current limiting means 16. The circuit isolating means 15 is mounted in the main body 1 and has a portion exposed outside of the main body 1 for selecting closing or opening a circuit in the main body 1 so as to supply or cut off power. The current limiting means 16 has a portion exposed outside of the main body 1. The blade 11 is connected to the first contact 161 of the current limiting means 16. The electrical conducting clip 20 is connected to the second contact 162 of the current limiting means 16. The blade 12 is connected to the first contact 151 of the circuit isolating means 15. The electrical conducting clip 19 is connected to the second contact 152 of the circuit isolating means 15.

In the power plug, the blade 11, the electrical conducting clip 20, and the current limiting means 16 are connected in series while the blade 12, the electrical conducting clip 19, and the current isolating means 15 are connected in series, and thus forms an electrical loop of dual safety protection. Therefore, when the user wants to use an electrical equipment connected to a power source by the power plug, the circuit isolating means 15 can be switched on to supply power to the electrical equipment. When the electrical equipment is not in use, the circuit isolating means 15 can be switched off to cut off power and allows the electrical equipment to be isolated from the power source to save power. When abnormal or excessive current such as overload occurs, the current limiting means 16 can be actuated to cut off the power source to trip the electrical equipment to achieve the purpose of electrical safety protection.

Please refer to FIG. 7, which shows another structure of the second embodiment according to the present invention. As shown, the circuit isolating means 15 is a switch with an indicating lamp (lamp not shown). The blade 11 is connected to the third contact 153 of the circuit isolating means 15 and then connected to the first contact 161 of the current limiting means 16. The electrical conducting clip 20 is connected to the second contact 162 of the current limiting means 16. The blade 12 is connected to the first contact 151 of the circuit isolating means 15. The electrical conducting clip 19 is connected to the second contact 152 of the circuit isolating means 15. Since the indicating lamp (not shown) is connected between the second contact 152 and the third contact 153 of the circuit isolating means 15, when the circuit isolating means 15 is switched on, the indicating lamp (not shown) can illuminate so as to increase the usefulness of the power plug.

The above embodiments are only for illustrating a preferred way of implementing the present invention, rather than limiting the scope of the present invention Any slight modification, change may be resorted to without losing the essence and spirit of the present invention

In light of the foregoing, the present invention employs a circuit isolating means and a current limiting means in the main body of a power plug such that, when an electrical equipment connected to a power source by the power plug is not in use, the circuit isolating means can be switched off to isolate the equipment from the power source to save power. Furthermore, when abnormal or excessive current occurs, the equipment can be tripped to achieve the purpose of electrical safety protection. It is believed that the present invention is a useful design with novel features. An early and favorable action is respectfully solicited.

I claim:

1. A power plug comprising a main body, two blades being provided at one end of said main body, two wires being provided at another end of said main body, a circuit isolating means mounted in said main body for selectively closing or opening a circuit in said main body so as to supply or cut off power, and a current limiting means; wherein one of said two blades is connected to one of said two wires by way of said circuit isolating means in series, the other of said two blades is connected to the other of said two wires by way of said current limiting means in series, so as to form an electrical loop of dual safety protection; whereby, said circuit isolating means can be switched off to isolate an electrical equipment from a power source to save power and achieve the purpose of electrical safety protection, said current limiting means can be actuated to trip the electrical equipment upon abnormal current such that the electrical equipment can be insulated from the power source to achieve the purpose of electrical safety protection.

2. The power plug of claim 1, wherein said circuit isolating means is a switch.

3. The power plug of claim 1, wherein said current limiting means is a fuse.

4. The power plug of claim 1, wherein said circuit isolating means is a switch with an indicating lamp.

5. A power plug comprising a main body, two blades symmetrical aligned at one end of said main body, two slots provided at another end of said main body, two electrical conducting clips corresponding to said two slots mounted in said main body, a circuit isolating means mounted in said main body for selectively closing or opening a circuit mounted in said main body so as to supply or cut off power, and a current limiting means mounted in said main body; wherein one of said two blades is connected to one of said two electrical conducting clips by way of said circuit isolating means in series, the other of said two blades is connected to the other of said two electrical conducting clips by way of said current limiting means in series, so as to form an electrical loop of dual safety protection; whereby, said circuit isolating means can be switched off to isolate an electrical equipment from a power source to save power and achieve the purpose of electrical safety protection when the electrical equipment is not in use, said current limiting means can be actuated to trip the electrical equipment upon abnormal current such that the electrical equipment can be insulated from the power source to achieve the purpose of electrical safety protection.

6. The power plug of claim 5, wherein said circuit isolating means is a switch.

7. The power plug of claim 5, wherein said current limiting means is a fuse.

8. The power plug of claim 5, wherein said circuit isolating means is a switch with an indicating lamp.
